(19) United States
(12) Patent Application Publication
(10) Pub. No.: US 2025/0169496 A1
(43) Pub. Date: May 29, 2025

(54) USE OF 2-AMINO-3-HYDROXY-3-METHYLBUTYRIC ACID AND/OR 2-AMINO-3-(4-HYDROXYPHENYL) BUTYRIC ACID

(71) Applicant: NANJING TIANNONG BIOTECHNOLOGY CO., LTD., Nanjing, Jiangsu (CN)

(72) Inventors: Shiguo CHEN, Nanjing (CN); He WANG, Nanjing (CN); Liru MI, Nanjing (CN); Yu Ji, Nanjing (CN); Qing LIU, Nanjing (CN); Aiping GUO, Nanjing (CN)

(73) Assignee: NANJING TIANNONG BIOTECHNOLOGY CO., LTD., Nanjing, Jiangsu (CN)

(21) Appl. No.: 18/717,097

(22) PCT Filed: Dec. 5, 2022
(86) PCT No.: PCT/CN2022/136475

§ 371 Date: Dec. 26, 2024

(30) Foreign Application Priority Data
Dec. 6, 2021 (CN) 202111476337.6

(51) Int. Cl. A01N 37/44; A01P 1/00; A01P 3/00; A01P 21/00

(52) U.S. Cl. CPC A01N 37/44; A01P 1/00; A01P 3/00; A01P 21/00

(57) ABSTRACT

A 2-amino-3-hydroxy-3-methylbutyric acid and/or 2-amino-3-(4-hydroxyphenyl) butyric acid are used as natural active substances to be developed as a plant immune resistance inducer which can be used for improving the resistance of plants to biotic stress and abiotic stress and effectively prevents infection of fungi, viruses and bacteria on plants and reduces pathogenic levels, moreover, the tolerance capability of plants to high-temperature, low-temperature, drought and salt stresses can be remarkably improved. The 2-amino-3-hydroxy-3-methylbutyric acid and 2-amino-3-(4-hydroxyphenyl) butyric acid have the characteristics of safety, environmental protection and high efficiency.

### TECHNICAL FIELD

The present invention pertains to the field of agricultural biopesticides and relates to use of 2-amino-3-hydroxy-3-methylbutyric acid and/or 2-amino-3-(4-hydroxyphenyl) butyric acid.

### BACKGROUND ART

Plant immune resistance inducers are a kind of new concept pesticides, which enhance plant resistance to disease and stress by activating the immune systems of plants and regulating the metabolism of plants. The plant immune resistance inducers per se do not have the activity of killing insects and bacteria. They prevent and control diseases and pests mainly through exogenous application to stimulate the plant's own natural immune system. Because they do not rely on exogenous pesticides to directly kill pathogens, it is not easy for diseases and pests to develop resistance to them, which is in line with the idea of achieving green prevention and control under the condition of effectively protecting agricultural biodiversity. In addition, in nature, the growth of plants is typically not subject to a single stress and instead, a plurality of stresses coexist. For example, drought stress and high-temperature stress often occur at the same time, causing more serious harm to plants. Although plants have their own immune systems, their resistance to stress is limited. The use of a plant immune resistance inducer can increase the stress resistance level of plants. The plant immune resistance inducer as an emerging pesticide provides a new train of thought for the sustainable development of agriculture and the effective green prevention and treatment of diseases, and is a main direction of the future development of green plant protection.

At present, extreme weather occurs frequently in the world, and the losses caused to agricultural production by major abiotic stresses such as high temperature, low temperature, drought and salt each year are enormous. Currently, the arid and semi-arid areas in the world account for more than 40% of the total cultivated land area, and drought is one of the most important stress factors affecting crop production. Secondly, high and low temperatures seriously affect the growth and development of plants, thereby affecting the yield and quality of the plants. In recent years, due to the global climate deterioration, drought, and high and low temperature agricultural disasters become more frequent, posing an increasing threat to food production security. Moreover, soil salinization is a major abiotic limiting factor hindering global crop growth and productivity, and the saline-alkali land area in China ranks third in the world, accounting for about 10% of the total saline-alkali land area in the world. Therefore, in view of the major abiotic stresses faced by different crops in current agricultural production, it is particularly urgent to develop green immune resistance inducer products aimed at reducing plant damage levels to ensure safe agricultural production.

In addition to abiotic stress, crops are also constantly threatened by a plurality of diseases and pests in the process of growth and development, and the occurrence and prevalence of some diseases typically will cause serious crop reduction or even total crop failure in a large area. Therefore, it is particularly important to establish a comprehensive control system against important agricultural pests and diseases. At present, the main measures for the prevention and control of agricultural plant diseases and pests are direct killing by pesticides. However, long-term and large-scale use of bactericides and insecticides not only brings a series of problems such as residual pollution, drug resistance, biodiversity reduction, and food safety, but also makes the traditional “killing” strategy of plant protection face the risk of failure. It is a serious threat to food production security and sustainable agricultural development strategies. Therefore, developing environmentally friendly, efficient and economical plant immune agents and reducing or inhibiting the morbidity level of crops before or in the early stage of crop disease by enhancing the plant's own resistance, thereby achieving the goal of using less or no chemical bactericides is of great significance to the realization of agricultural green production.

2-amino-3-hydroxy-3-methylbutyric acid, with a molecular formula: C₅H₁₁NO₃ and a molecular weight of 133 g/mol, is a new type of amino acid compound, and a colorless transparent acicular crystal. At present, there is very little research on this compound. The earliest report on 2-amino-3-hydroxy-3-methylbutyric acid was in 1968, and the scientists synthesized this compound by a chemical method and found that L-2-amino-3-hydroxy-3-methylbutyric acid could inhibit the synthesis of valine in Lactobacihs arabinosu(Edwards & Minthorn, 1968). In 2010, Takumi et al. isolated 2-amino-3-hydroxy-3-methylbutyric acid from Pleurocybella porrigens, a mushroom bacterium, for the first time. The compound was weakly toxic to rat brain glial cells at a concentration of 10μgmL⁻¹ (Takumi et al., 2010). Up to now, there are few studies on 2-amino-3-hydroxy-3-methylbutyric acid, and no studies, reports and patents related to plant immune resistance induction activity.

2-amino-3-(4-hydroxyphenyl) butyric acid, with a molecular formula: C₁₀H₁₃NO₃ and a molecular weight of 195 g/mol, is a new type of amino acid compound, and a colorless transparent crystal. At present, there are few reports about this compound. The earliest report on 2-amino-3-(4-hydroxyphenyl) butyric acid was made in 1989, and optical isomers with high purity were obtained by the method of chemical synthesis (Nicolas et al., 1989). In 1999, researchers used phenol, α-ketobutyric acid and ammonia as substrates and used Tyrosine phenol-lyase (TPL) of Citrobacter freundii to obtain 2-amino-3-(4-hydroxyphenyl) butyric acid through catalytic reaction in vitro (Kim & Cole, 1999). In recent years, the studies on this compound are limited to the aspects of chemical synthesis pathway and chiral resolution (Peter et al., 1999, 2000; Grobuschek et al., 2002; Vékes et al., 2002; Péter & Tóth, 2015). So far, there are no reports that this compound is a natural product.

### SUMMARY OF THE INVENTION

The objective of the present invention is to address the above shortcomings of the prior art and provide biological extraction of 2-amino-3-hydroxy-3-methylbutyric acid and its application as a plant immune resistance inducer.

Recently, we successfully isolated and purified 2-amino-3-hydroxy-3-methylbutyric acid and 2-amino-3-(4-hydroxyphenyl) butyric acid from saprophytic plant pathogenic fungi Alternaria alternata, systematically studied their plant immunity and resistance induction activity and found that in the aspect of resistance to biotic stress, 2-amino-3-hydroxy-3-methylbutyric acid and 2-amino-3-(4-hydroxyphenyl) butyric acid can effectively inhibit the occurrence and diffusion of viruses, fungi and bacteria on plant leaves; in the aspect of inducing abiotic stress of plants, 2-amino-3-hydroxy-3-methylbutyric acid and 2-amino-3-(4-hydroxyphenyl) butyric acid can effectively alleviate the damage of high temperature, low temperature, drought and salt to plants. The objective of the present invention can be achieved by the following technical solution:

2-amino-3-hydroxy-3-methylbutyric acid and 2-amino-3-(4-hydroxyphenyl) butyric acid are natural products isolated from Alternaria alternata. The structural formula of 2-amino-3-hydroxy-3-methylbutyric acid is as follows:

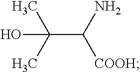

The structural formula of 2-amino-3-(4-hydroxyphenyl) butyric acid is as follows:

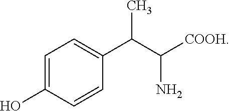

Use of 2-amino-3-hydroxy-3-methylbutyric acid and/or 2-amino-3-(4-hydroxyphenyl) butyric acid in the preparation of plant immune resistance inducers.

Use of 2-amino-3-hydroxy-3-methylbutyric acid and/or 2-amino-3-(4-hydroxyphenyl) butyric acid in improving the resistance of plants to biotic stress and abiotic stress.

Use of 2-amino-3-hydroxy-3-methylbutyric acid and/or 2-amino-3-(4-hydroxyphenyl) butyric acid in improving the resistance of plants to high-temperature, low-temperature, drought and salt stresses.

Use of 2-amino-3-hydroxy-3-methylbutyric acid and/or 2-amino-3-(4-hydroxyphenyl) butyric acid in improving the resistance of plants to fungal, bacterial and viral stresses.

Use of 2-amino-3-hydroxy-3-methylbutyric acid and/or 2-amino-3-(4-hydroxyphenyl) butyric acid in the prevention and treatment of fungal, bacterial and/or viral diseases of plants.

The fungal disease is preferably wheat powdery mildew, the bacterial disease is preferably Pseudomonas syringae disease, and the viral disease is preferably tomato spotted wilt.

The plants are selected from grain crops, cash crops and vegetables. The grain crop is preferably wheat, the cash crop is preferably ryegrass, tea or cotton, and the vegetable is preferably tomato.

A plant immune resistance inducer, containing 2-amino-3-hydroxy-3-methylbutyric acid.

As a preferred choice of the present invention, the plant immune resistance inducer contains component A: any one or two of 2-amino-3-hydroxy-3-methylbutyric acid and 2-amino-3-(4-hydroxyphenyl) butyric acid; and component B: surfactant.

As a more preferred choice of the present invention, the surfactant is Tween 20, and the concentration of Tween 20 in the plant immune resistance inducer is preferably 0.02% (v/v).

As a still more preferred choice of the present invention, the concentration of 2-amino-3-hydroxy-3-methylbutyric acid in the plant immune resistance inducer is 0.1-10,000 nM.

Existing studies on 2-amino-3-hydroxy-3-methylbutyric acid and 2-amino-3-(4-hydroxyphenyl) butyric acid do not involve the reports in the fields of microbial metabolites and biopesticides. Plant immune resistance inducers are a new type of pesticides and a main development direction of green prevention and control in the field of plant protection in the future. The development of immune resistance inducers in China is in an initial stage and only a few products have been officially registered. Therefore, developing natural plant immune resistance inducers and promoting their industrialization is of great significance to ensuring the safety of agricultural production and improving the competitiveness of agricultural products. 2-amino-3-hydroxy-3-methylbutyric acid and 2-amino-3-(4-hydroxyphenyl) butyric acid perform well in related induced immune stress tests. They can improve the resistance of plants to biotic stress and abiotic stress.

The details and implementation plan of the method for preventing and treating diseases by the natural metabolite 2-amino-3-hydroxy-3-methylbutyric acid or 2-amino-3-(4-hydroxyphenyl) butyric acid isolated from Alternaria alternata are as follows: within a concentration range of 0.1-10,000 nM (surfactant Tween 20 (0.02% (v/v) is added), it can effectively inhibit the infection and diffusion of viruses, fungi and bacteria on plants, inhibit the occurrence and spread of diseases, and improve the resistance of plants to high-temperature, low-temperature, drought and salt stresses.

A method for improving the resistance of plants to biotic stress, comprising applying in advance a plant immune resistance inducer provided by the present invention; the biotic stress is selected from any one or more of fungal, bacterial and viral stresses.

A method for preventing and treating tomato spotted wilt by 2-amino-3-hydroxy-3-methylbutyric acid or 2-amino-3-(4-hydroxyphenyl) butyric acid, wherein within a concentration range of 0.1-10 nM (surfactant Tween 20 (0.02% (v/v) is added), it can significantly inhibit virus diffusion 3 days after the tobacco is inoculated with tomato spotted wilt virus (TSWV). After 15 days, the disease index of the tobacco treated with 2-amino-3-hydroxy-3-methylbutyric acid is significantly reduced. At a low concentration of 10 nM, 2-amino-3-hydroxy-3-methylbutyric acid can effectively inhibit the expression of TSWV on tobacco leaves, and the disease index, relative immune effect and virus content are 29.01, 67.59% and 0.13, respectively. At a low concentration of 10 nM, 2-amino-3-(4-hydroxyphenyl) butyric acid can effectively inhibit the expression of TSWV on tobacco leaves, and the disease index, relative immune effect and virus content are 25.27, 67.24% and 0.24, respectively.

A method for preventing and treating wheat powdery mildew by 2-amino-3-hydroxy-3-methylbutyric acid or 2-amino-3-(4-hydroxyphenyl) butyric acid, wherein within a concentration range of 10-10,000 nM (surfactant Tween 20 (0.02% (v/v) is added), the investigation made 10 days after the wheat was inoculated with powdery mildew fungi found that with the increase of treatment concentration, the disease index of the wheat infected with powdery mildew decreased, and the relative immune effect increased, and when it was treated with 2-amino-3-hydroxy-3-methylbutyric acid at a high concentration of 10,000 nM, the disease index was 30.89 and the relative immune effect was 65.68%. The observation of mycelium distribution on wheat leaves found that the number of mycelia and conidium yield decreased significantly with the increase of concentration. When it was treated with 2-amino-3-(4-hydroxyphenyl) butyric acid at a high concentration of 10,000 nM, the disease index was 27.59 and the relative immune effect was 71.12%. The observation of mycelium distribution on wheat leaves found that the number of mycelia and conidium yield decreased significantly with the increase of concentration.

The efficacy of 2-amino-3-hydroxy-3-methylbutyric acid applied in the field shows that at a treatment concentration of 1,000 nM, the disease index, relative immune effect and thousand kernel weight of wheat are 48.64, 38.74% and 32.61 g, respectively, all obviously better than those of the Atailing treatment group and the additive control group. The efficacy results of 2-amino-3-(4-hydroxyphenyl) butyric acid in field application show that at a treatment concentration of 1,000 nM, the disease index, relative immune effect and thousand kernel weight of wheat are 28.37, 47.28% and 37.92 g, respectively, all obviously better than those of the Atailing treatment group and the additive control group. To sum up, 2-amino-3-(4-hydroxyphenyl) butyric acid plays a significant role in inhibiting the occurrence and diffusion of wheat powdery mildew.

To sum up, 2-amino-3-hydroxy-3-methylbutyric acid and 2-amino-3-(4-hydroxyphenyl) butyric acid play a significant role in inhibiting the occurrence and diffusion of wheat powdery mildew.

A method for preventing and treating bacterial diseases by 2-amino-3-hydroxy-3-methylbutyric acid or 2-amino-3-(4-hydroxyphenyl) butyric acid, wherein within a concentration range of 10-10,000 nM (surfactant Tween 20 (0.02% (v/v) is added), with the increase of treatment concentration, the accumulation of bacteria PstDC3000 in Arabidopsis leaves gradually decreases and when the treatment concentration of 2-amino-3-hydroxy-3-methylbutyric acid is 10,000 nM, the number of bacteria in leaves per milligram is 3.81×10⁵, decreasing by 88.06% compared to the blank control, and the disease index is 30.28. when the treatment concentration of 2-amino-3-(4-hydroxyphenyl) butyric acid is 10,000 nM, the number of bacteria in leaves per milligram is 2.77×10⁵, decreasing by 91.37% compared to the blank control, and the disease index is 27.17. These results indicate that 2-amino-3-hydroxy-3-methylbutyric acid or 2-amino-3-(4-hydroxyphenyl) butyric acid can stimulate Arabidopsis autoimmunity, inhibit the reproduction of bacteria in plants, reduce the accumulation of bacteria and delay and inhibit the development of diseases.

A method for improving the resistance of plants to abiotic stress, comprising applying a plant immune resistance inducer provided by the present invention; the abiotic stress is selected from any one or more of high-temperature, low-temperature, drought and salt stresses.

A method for improving the resistance of plants to high temperature by 2-amino-3-hydroxy-3-methylbutyric acid, wherein a 2-amino-3-hydroxy-3-methylbutyric acid solution (surfactant Tween 20 (0.02% (v/v) is added) in a concentration range of 10-10,000 nM treated and induced Arabidopsis in the seeding stage, and it was found that the photosynthetic performance index (PI_{ABS}) of the plants in the treatment group was higher than that in the control group and the heat damage index was lower than that in the control group after the plants were treated at a high temperature of 45° C. for 12 h and recovered at room temperature for 7 d. The results show that exogenous spraying of the 2-amino-3-hydroxy-3-methylbutyric acid solution effectively alleviated the damage level of high temperature to seedlings.

A method for improving the resistance of plants to high temperature by 2-amino-3-(4-hydroxyphenyl) butyric acid, wherein a 2-amino-3-(4-hydroxyphenyl) butyric acid solution (surfactant Tween 20 (0.02% (v/v) is added) in a concentration range of 1-1,000 nM treated and induced ryegrass in the seeding stage, and it was found that the photosynthetic performance index (PI_{ABS}) of the plants in the treatment group was higher than that in the control group and the heat damage index was lower than that in the control group after the plants were treated at a high temperature of 45° C. for 12 h and recovered at room temperature for 7 d. The results show that exogenous spraying of the 2-amino-3-(4-hydroxyphenyl) butyric acid solution effectively alleviated the damage level of high temperature to seedlings.

A method for improving the resistance of plants to low temperature by 2-amino-3-hydroxy-3-methylbutyric acid, wherein a 2-amino-3-hydroxy-3-methylbutyric acid solution (surfactant Tween 20 (0.02% (v/v) is added) in a concentration range of 10-10,000 nM was sprayed on the leaf surface of tea seedlings, and it was found that after 24 h of low-temperature stress at −4° C., the photosynthetic performance index (PI_{ABS}) of tea seedlings treated at 10 nM, 100 nM, 1,000 nM and 10,000 nM was significantly higher than that of the control group, and the cold damage index was obviously lower than that of the control group, indicating that 2-amino-3-hydroxy-3-methylbutyric acid has effectively alleviated the damage of low temperature to tea seedlings, and improved the resistance of tea to low-temperature stress.

A method for improving the resistance of plants to low temperature by 2-amino-3-(4-hydroxyphenyl) butyric acid, wherein a 2-amino-3-(4-hydroxyphenyl) butyric acid solution (surfactant Tween 20 (0.02% (v/v) is added) in a concentration range of 1-1,000 nM was sprayed on the leaf surface of tea seedlings, and it was found that after 24 h of low-temperature stress at −4° C., the photosynthetic performance index (PI_{ABS}) of tea seedlings treated at 1 nM, 10 nM, 100 nM and 1,000 nM was significantly higher than that of the control group, and the cold damage index was obviously lower than that of the control group, indicating that 2-amino-3-(4-hydroxyphenyl) butyric acid has effectively alleviated the damage caused by low temperature to tea seedlings, and improved the resistance of tea to low temperature stress.

A method for improving the resistance of plants to drought stress by 2-amino-3-hydroxy-3-methylbutyric acid or 2-amino-3-(4-hydroxyphenyl) butyric acid, wherein 100 and 1,000 nM 2-amino-3-hydroxy-3-methylbutyric acid or 2-amino-3-(4-hydroxyphenyl) butyric acid solutions (surfactant Tween 20 (0.02% (v/v) is added) were sprayed on the leaf surface of hydroponic wheat with two leaves and one shoot and it was found that under the stress of 25% PEG-6000, the biomass of wheat treated at 100 nM and 1,000 nM was significantly higher than that of the control group. The results indicate that 2-amino-3-hydroxy-3-methylbutyric acid or 2-amino-3-(4-hydroxyphenyl) butyric acid has improved the resistance of wheat to drought stress.

A method for improving the resistance of plants to salt stress by 2-amino-3-hydroxy-3-methylbutyric acid or 2-amino-3-(4-hydroxyphenyl) butyric acid, wherein a 2-amino-3-hydroxy-3-methylbutyric acid or 2-amino-3-(4-hydroxyphenyl) butyric acid solution (surfactant Tween 20 (0.02% (v/v) is added) in a concentration range of 1-1,000 nM was sprayed on the leaf surface of hydroponic cotton in the two-true-leaf stage and it was found that under the stress of 100 mM NaCl, and in the treatment group sprayed with 2-amino-3-hydroxy-3-methylbutyric acid or 2-amino-3-(4-hydroxyphenyl) butyric acid, respectively, the death rate and salt damage index of cotton were lower than those of the control group. The results indicate that 2-amino-3-hydroxy-3-methylbutyric acid and 2-amino-3-(4-hydroxyphenyl) butyric acid have improved the tolerance level of cotton to salt.

### Technical Advancement and Beneficial Effects

The present invention has the following main advantages and positive effects:

2-amino-3-hydroxy-3-methylbutyric acid and 2-amino-3-(4-hydroxyphenyl) butyric acid are both natural products with simple structures and convenient biological extraction methods. As the present invention has confirmed that 2-amino-3-hydroxy-3-methylbutyric acid and 2-amino-3-(4-hydroxyphenyl) butyric acid both can induce plants to produce immune activity against some of the serious diseases in agricultural production, and can induce plants to generate resistance to the main abiotic stresses currently faced in agricultural production, they have the potential to be developed into natural plant immune resistance inducers.

The present invention found that 2-amino-3-hydroxy-3-methylbutyric acid and 2-amino-3-(4-hydroxyphenyl) butyric acid both had high broad-spectrum immune-inducing activity, and at a low concentration of 0.1 nM, could induce immune response of tobacco to prevent the occurrence and spread of tomato spotted wilt; at a concentration of 1,000 nM, 2-amino-3-hydroxy-3-methylbutyric acid could induce wheat to generate a 47.24% relative immune effect on powdery mildew, and 2-amino-3-(4-hydroxyphenyl) butyric acid could induce wheat to generate a 57.40% relative immune effect on powdery mildew; at a concentration of 100 nM, could inhibit the accumulation of Pseudomonas syringae PstDC3000 in Arabidopsis leaves and reduce the disease index of Arabidopsis. In the aspect of dealing with abiotic stress, 2-amino-3-hydroxy-3-methylbutyric acid at a concentration of 10-10,000 nM could induce Arabidopsis to increase the resistance to high temperature, as well as the resistance of wheat to drought and the resistance of tea to low temperature; when 2-amino-3-(4-hydroxyphenyl) butyric acid was at a concentration of 1-10,000 nM, it could induce Arabidopsis to increase the resistance to high temperature, as well as the resistance of wheat to drought and the resistance of tea to low temperature. When 2-amino-3-hydroxy-3-methylbutyric acid and 2-amino-3-(4-hydroxyphenyl) butyric acid were at a concentration of 100 nM, they both could significantly improve the resistance of cotton to salt. 2-amino-3-hydroxy-3-methylbutyric acid and 2-amino-3-(4-hydroxyphenyl) butyric acid are efficient and environmentally friendly biopesticides with a low dosage and no environmental pollution, indicating that the substances have a great utilization value and a broad prospect in agricultural production.

The present invention can be used to control major fungal diseases occurring in farmland, such as wheat powdery mildew; viral diseases, such as tomato spotted wilt; bacterial diseases, such as diseases caused by Pseudomonas syringae. This indicates that the compounds can induce immune response of plants to a plurality of diseases. Moreover, they can induce plants to resist a plurality of abiotic stresses in nature, such as high-temperature, low-temperature, drought and salt stresses, and provide a technical reference for alleviating the damage to plants caused by a plurality of stresses.

The present invention found that treatment of stems and leaves with 2-amino-3-hydroxy-3-methylbutyric acid or 2-amino-3-(4-hydroxyphenyl) butyric acid could prevent the occurrence and spread of a plurality of major diseases in agricultural production, and reduce the inhibition of a plurality of abiotic stresses in the growth and development of crops. 2-amino-3-hydroxy-3-methylbutyric acid and 2-amino-3-(4-hydroxyphenyl) butyric acid are convenient in use and can play a role of advance prevention, lower the levels of plant damage caused by a plurality of biotic and abiotic stresses, reduce the use of pesticides and save production costs. Further, as 2-amino-3-hydroxy-3-methylbutyric acid and 2-amino-3-(4-hydroxyphenyl) butyric acid are both naturally existing metabolites with a simple structure and are a-amino acids, they have high environmental and biological safety and fall into the category of green and efficient biopesticides.

### DETAILED DESCRIPTION

The inventors isolated 2-amino-3-hydroxy-3-methylbutyric acid and 2-amino-3-(4-hydroxyphenyl) butyric acid from Alternaria alternata, purified them and identified their structures. Afterwards, they studied the bioactivity, application scope and crop safety of the substances and found that the substances were natural plant immune resistance inducers and had a potential to be developed into biopesticides. At the same time, the research approach provided a new development direction for the development of biopesticides, the prevention and treatment of diseases and the relief of abiotic stress. The substantial features of the present invention can be reflected in the following implementation manners and embodiments, but they shall not be regarded as any limitation to the present invention.

### Embodiment 1 Biosynthesis, Extraction Method and Structural Identification of the Compounds Provided by the Present Invention

(1) Culturing of Alternaria alternata

Glucose sodium nitrate medium: glucose, 40.0 g; NaNO₃, 1.0 g; NH₄Cl, 0.25 g; KH₂PO₄, 1.0 g; KCl, 0.25 g; NaCl, 0.25 g; MgSO₄·7H₂O, 0.5 g; FeSO₄·7H₂O, 0.01 g; ZnSO₄·7H₂O, 0.01 g;yeast extract, 1 g. Add water till 1 L and adjust pH to 5.5.

Method for culturing Alternaria alternata: Activate and preserve strains in a PDA medium, select colonies with consistent growth after 7 days, make them into bacteria cakes with a diameter of 5 mm and inoculate them into 500 mL of medium in an inoculum size of 100 mL per bacteria cake. Put the medium of inoculated bacteria in a constant-temperature shaking table, and culture it in the dark at 140 rpm, 25° C.

### (2) Extraction of Compounds

Isolate mycelia from a fermentation broth by centrifuge at 10,000 rpm for 5 min after culturing for 7 days. Remove the supernatant, remove the mycelia from the bottom of the bottle, put them in a mortar, and quickly grind them into uniform powder with liquid nitrogen. Put the powder in a centrifuge tube, add 5 mL of water, shake up, rest and extract for 1 h. Remove the precipitate by means of centrifugation at 10,000 rpm for 5 min. The supernatant obtained is a crude amino acid extract.

### (3) Isolate and Purify 2-Amino-3-Hydroxy-3-Methylbutyric Acid by the HPLC Method:

Isolate and purify the crude amino acid extract by high performance liquid chromatography (HPLC) and elute it by the double mobile phase method. The elution conditions are A: 60% water (containing 0.1% formic acid), B: 40% acetonitrile, the ultraviolet detection wavelength is 210 nM, and the flow rate is 2 mL min⁻¹. The isolation can remove impurities in the crude extract and obtain a single component of 2-amino-3-hydroxy-3-methylbutyric acid, with a peak time of 3.5 min. This method can effectively isolate this compound from Alternaria alternata.

Identify the structure of the colorless acicular crystal obtained from the isolation by magnetic resonance imaging (NMR) and mass spectrometry (MS).

The NMR results are as follows: ¹H NMR(500 MHz, Deuterium Oxide) δ 3.49(s, 1H, CHNH₂), 1.33(s, 1H, CCH₃), 1.12 (s, 1H,CCH₃).

¹³C NMR (125 MHz, Deuterium Oxide) δ 173.86 (CHCOOH), 76.71 (CHNH₂), 69.79 (COH), 27.38 (CCH₃), 23.17 (CCH₃).

MS shows that the molecular ion peak of the compound is: 134.0814 [M+H]⁺. It is determined that its molecular formula is: C₅H₁₁NO₃. Combined with the results of NMR hydrogen and carbon spectra, it is determined that the compound is 2-amino-3-hydroxy-3-methylbutyric acid.

### (3) Isolate and Purify 2-Amino-3-(4-Hydroxyphenyl) Butyric Acid by the HPLC Method:

Isolate and purify the crude amino acid extract by high performance liquid chromatography (HPLC) and elute it by the double mobile phase method. The elution conditions are A: 60% water (containing 0.1% formic acid), B: 40% acetonitrile, the ultraviolet detection wavelength is 256 nM, and the flow rate is 2 mL min⁻¹. The isolation can remove impurities in the crude extract and obtain a single component of 2-amino-3-(4-hydroxyphenyl) butyric acid, with a peak time of 8.7 min. This method can effectively isolate this compound from Alternaria alternata.

Identify the structure of the white crystal obtained from the isolation by NMR and MS. The NMR results are as follows:
¹H NMR (500 MHz, Deuterium Oxide) δ 7.12-6.79 (m, 4H, Ph), 3.76-3.69 (dd, J1=5 Hz, J2=10 Hz, 1H, CH—NH₂), 3.12-3.09 (m, 1H, CHCH₃), 1.25-1.21 (dd, J₁=5 Hz, J₂=10 Hz, 3H, CHCH₃);
¹³C NMR (125 MHz, Deuterium Oxide) δ 174.03 (CHCOOH), 155.01 (Ph), 129.24 (Ph), 129.14 (Ph), 115.93 (Ph), 115.78 (Ph), 61.08 (CHNH₂), 40.04 (CHCH₃), 14.28 (CHCH₃).

MS shows that the molecular ion peak of the compound is: 196.0967 [M+H]⁺. It is determined that its molecular formula is: C₁₀H₁₃NO₃. Combined with the results of NMR hydrogen and carbon spectra, it is determined that the compound is 2-amino-3-(4-hydroxyphenyl) butyric acid.

### Embodiment 2 2-Amino-3-Hydroxy-3-Methylbutyric Acid and 2-Amino-3-(4-Hydroxyphenyl) Butyric Acid Induce Tobacco to Resist Infection of Tomato Spotted Wilt Virus

Obtain the tomato spotted wilt virus from Yunnan Province, China, store the initial virus source in a −80° C. refrigerator, activate the virus by inoculating it by friction inoculation on Nicotiana benthamiana leaves, extract viral plasmids, transform them by Escherichia coli competent cells, spread them onto a resistant plate for culture, pick a single colony for PCR screening, select positive colonies for sequencing and subsequent plasmid extraction, add the plasmids with normal sequencing to agrobacterium competent cells, transform the agrobacterium by the electric shock method, spread the transformed agrobacterium solution on the corresponding resistance screening plate, and culture it at 28° C.(±1) for 48 h. Pick a single agrobacterium colony on the transformation plate, place it in 5 mL of LB medium with the corresponding resistance and culture it at 28° C. and 180 rpm overnight. Centrifuge at 6,000 rpm for 2 min, collect the bacteria, suspend the bacteria with a treatment buffer (10 mM MgCl₂, 10 mM MES, 10 μM Acetosyringone) until the OD₆₀₀ of the suspension is 0.5, treat it at 28° C. in a dark place for 3 h and keep it for future use.

Take 2-amino-3-hydroxy-3-methylbutyric acid, dissolve it with distilled water, then dilute the solution with distilled water by gradient into 0 nM, 0.1 nM, 1 nM and 10 nM solutions. Sow Nicotiana benthamiana seeds in a small pot, and culture them at 24(±1)° C., 12 h/12 h illumination for 5 weeks. Select healthy tobacco plants (plants with 8-10 leaves are appropriate), spray 2-amino-3-hydroxy-3-methylbutyric acid solutions at the above concentrations on leaves and stems twice at an interval of 24 h. After 24 hours, suck an agrobacterium solution at a uniform concentration with a 1 mL syringe, press the injection port of the syringe directly on a small hole on the back of a tobacco leaf, and slowly push the bacterial solution into the hole so that the whole leaf is soaked. Culture the soaked tobacco at 24(±1)° C. 12 h/12 h illumination. Observe under a microscope after 3 d and make record; meanwhile, take a sample, analyze the grayscale of protein bands by using Western blot and Image J software, and determine the relative protein content of virus in leaves. Observe the morbidity of the tobacco leaves after 15 days, record the disease index with reference to GB/T 23222-2008 Grade and Investigation Method of Tobacco Diseases and Insect Pests. The formula is as follows:

$$\begin{matrix}Disease index = \frac{\sum [ ( Number of diseased leaves at each level \times Relative level value ) ] \times 100}{Total number of investigated leaves \times 9} \\ Relative immune effect = \frac{Disease index of blank control - Disease index of treatment}{Disease index of black control} \times 100\end{matrix}$$

Grading standard of tomato spotted wilt viruses (grading survey with plant as a unit):
Level 0: No disease in the whole plant;
Level 1: The shoot and leaf veins are clear or the leaves are slightly mottled, and the diseased plant is not dwarfed obviously;
Level 3: One third of the leaves are mottled, but the leaves are not deformed, or the plant is dwarfed to more than three quarters of the normal plant height;
Level 5: One third to a half of the leaves are mottled, or a minority of leaves are deformed, or the main veins turn black, or the plant is dwarfed to two thirds to three quarters of the normal plant height;
Level 7: A half to two thirds of the leaves are mottled, or deformed or a minority of major lateral veins are dead, or the plant is dwarfed to a half to two thirds of the normal plant height;
Level 9: The leaves of the whole plant are mottled, or seriously deformed or dead, or the diseased plant is dwarfed to more than a half of the normal plant height.

TABLE 1
Effects of 2-amino-3-hydroxy-3-methylbutyric
acid at different concentrations on infection
of tomato spotted wilt virus on tobacco

| Treatment | | Relative immune | Viral protein |
|---|---|---|---|
| concentration | Diseaseindex | effect(%) | content |
| 0 | 89.51 ± 1.75 a | 0 | 0.58 ± 0.031 a |
| 0.1 nM | 58.64 ± 2.31 b | 34.48 | 0.41 ± 0.029 b |
| 1 nM | 40.74 ± 3.02 c | 54.48 | 0.30 ± 0.012 c |
| 10 nM | 29.01 ± 2.87 d | 67.59 | 0.13 ± 0.005 d |

The results in Table 1 show that when the concentration range of 2-amino-3-hydroxy-3-methylbutyric acid is 0.1-10 nM, each treatment can significantly reduce the infection of tomato spotted wilt virus on tobacco, the disease index of tobacco infected with tomato spotted wilt virus is lower than 60, the relative immune effect is more than 30%, and in this concentration range, the disease index of tobacco infected with tomato spotted wilt virus decreases significantly with the increase of concentration, the relative immune effect increases significantly compared to the control, and the viral protein content in tobacco leaves decreases significantly. When the treatment concentration is 10 nM, the immune effect of tobacco against tomato spotted wilt virus is the best, and the disease index, relative immune effect and virus content are 29.01, 67.59% and 0.13, respectively. The above results indicate that 2-amino-3-hydroxy-3-methylbutyric acid can improve the immunity of tobacco against tomato spotted wilt virus and effectively inhibit the diffusion of tomato spotted wilt virus in tobacco.

The same method is used to investigate the effect of 2-amino-3-(4-hydroxyphenyl) butyric acid in inducing tobacco to resist infection of tomato spotted wilt virus. The results are shown in Table 2:

TABLE 2
Effects of 2-amino-3-(4-hydroxyphenyl) butyric
acid at different concentrations on infection
of tomato spotted wilt virus on tobacco

| Treatment | | Relative immune | Viral protein |
|---|---|---|---|
| concentration | Disease index | effect (%) | content |
| 0 | 77.16 ± 5.31 a | 0 | 0.54 ± 0.025 a |
| 0.1 nM | 36.62 ± 0.87 b | 52.54 | 0.34 ± 0.004 b |
| 1 nM | 29.83 ± 2.31 c | 61.34 | 0.28 ± 0.012 c |
| 10 nM | 25.27 ± 3.49 c | 67.24 | 0.24 ± 0.019 d |

The results in Table 2 show that2-amino-3-(4-hydroxyphenyl) butyric acid at as low as 0.1 nM can significantly reduce the infection of tomato spotted wilt virus on tobacco, the disease index of tobacco infected with tomato spotted wilt virus is lower than 50, the relative immune effect is more than 50%, and in this concentration range, the disease index of tobacco infected with tomato spotted wilt virus decreases gradually with the increase of concentration, the relative immune effect increases significantly compared to the control, and the viral protein content in tobacco leaves decreases significantly. When the treatment concentration is 10 nM, the immune effect of tobacco against tomato spotted wilt virus is the best, and the disease index, relative immune effect and virus content are 25.27, 67.24% and 0.24, respectively. The above results indicate that 2-amino-3-(4-hydroxyphenyl) butyric acid can improve the immunity of tobacco against tomato spotted wilt virus and effectively inhibit the diffusion of tomato spotted wilt virus in tobacco.

### Embodiment 3 2-Amino-3-Hydroxy-3-Methylbutyric Acid and 2-Amino-3-(4-Hydroxyphenyl) Butyric Acid Induce Arabidopsisto Resist Infection of Pseudomonas syringae

Take 2-amino-3-hydroxy-3-methylbutyric acid, dissolve it in sterile water, dilute the solution with sterile water by gradient into 100 nM, 1,000 nM and 10,000 nM solutions, set a blank control, and meanwhile add 0.02% Tween 20 as a surfactant. Spread Pseudomonas syringaePstDC3000 on an LB plate, and culture it at 28° C. for 48h; pick a monoclonal colony, inoculate it in a 50 mL centrifuge tube containing 2 mL of medium, culture it on a shaker at 28° C., 250 rpm, monitor changes of OD₆₀₀ of the bacterial solution once every 1-2 h, and stop bacteria culturing before OD₆₀₀ reaches 0.8; transfer 1 mL of the bacterial solution to a sterile 1.5 mL centrifuge tube, centrifuge it at 8000 rpm for 2 min, and collect the precipitate; remove the supernatant, wash the precipitate with 10 mM magnesium chloride for three times and centrifuge, lastly re-suspend PstDC3000 in the 10 mM magnesium chloride until its OD₆₀₀ reaches 0.001, and keep it for future use. Soake Arabidopsis seeds in 75% alcohol for 3 min, then wash them with sterile water for 4 times, inoculate it in culture dishes filled with ½ MS medium, 12 seeds per dish, vernalize the ½ MS culture dishes containing seeds at 4° C. for 3 d to break dormancy, then put them in a 22° C. culture room with luminous intensity of 100μE m⁻²s-¹(16 hillumination/8 h darkness), slowly pour the above 2-amino-3-hydroxy-3-methylbutyric acid at different concentrations into the culture dishes until the entire Arabidopsis seedlings are submerged after the seedlings have grown for 2 weeks, maintain this state for 2-3 minutes, and then pour the treatment solution out of the culture dishes, treat it once every 24 h, twice in total, inoculate PstDC3000 suspension (OD₆₀₀=0.01) to Arabidopsis leaves by the same submerging method 24 h after the second treatment, seal the culture dishes with medical breathable adhesive after the inoculation, put them in the culture room for continued culturing. 3 d after, determine the number of bacteria after different treatments, observe the morbidity of Arabidopsis, and calculate the disease index by the method same as the disease index calculation formula in Embodiment 2.

Grading standard of diseases caused by PstDC3000(with leaf as a unit):
Level 0: No disease spot on the leaf surface;
Level 1: The area of the disease spots accounts for 0%-10% of the whole leaf area;
Level 2: The area of the disease spots accounts for 10%-25% of the whole leaf area;
Level 3: The area of the disease spots accounts for 25%-50% of the whole leaf area;
Level 4: The area of the disease spots accounts for 50%-75% of the whole leaf area;
Level 5: The area of the disease spots accounts for 750%-100% of the whole leaf area.

TABLE 3
Effects of2-amino-3-hydroxy-3-methylbutyric
acid at different concentrations on the number
of bacteria in leaves and on disease index

| Treatment | | |
|---|---|---|
| concentration | CFU(mg) | Diseaseindex |
| 0 | 3.19 × 10⁶ | 72.22 ± 0.98 a |
| 100 nM | 9.46 × 10⁵ | 40.90 ± 2.41 b |
| 1,000 nM | 7.11 × 10⁵ | 38.90 ± 1.96 b |
| 10,000 nM | 3.81 × 10⁵ | 30.28 ± 7.08 c |

The results in Table 3 show that with the increase of the concentration of 2-amino-3-hydroxy-3-methylbutyric acid, the number of bacteria per mg of leaves decreases gradually. When the treatment concentration is 100 nM, 1,000 nM and 10,000 nM, the number of bacteria per mg of leaves decreases by 70.34%, 77.71% and 88.06%, respectively and the disease index decreases by 43.22%, 45.60% and 58.07%, respectively. These results indicate that 2-amino-3-hydroxy-3-methylbutyric acid can stimulate plants to generate immunity against Pseudomonas syringae, inhibit the accumulation of bacteria in plant leaves and reduce the morbidity level of the plants.

By the same method, observe the effect of 2-amino-3-(4-hydroxyphenyl) butyric acid in inducing Arabidopsis to resist infection of Pseudomonas syringae. The results are shown in Table 4:

TABLE 4
Effects of 2-amino-3-(4-hydroxyphenyl) butyric
acidat different concentrations on the number
of bacteria in leaves and on disease index

| Treatment concentration | CFU/mg | Disease index |
|---|---|---|
| 0 | 3.21 × 10⁶ | 81.94 ± 1.96 a |

| | | | |
|---|---|---|---|
| 100 | nM | 4.43 × 10⁵ | 40.06 ± 0.98 b |
| 1,000 | nM | 3.04 × 10⁵ | 36.81 ± 0.28 c |
| 10,000 | nM | 2071 × 10⁵ | 27.17 ± 1.70 d |

The results in Table 4 show that with the increase of the concentration of 2-amino-3-(4-hydroxyphenyl) butyric acid, the number of bacteria per mg of leaves decreases gradually. When the treatment concentration is 100 nM, 1,000 nM and 10,000 nM, the number of bacteria per mg of leaves decreases by 86.20%, 90.53% and 91.37%, respectively and the disease index decreases by 51.11%, 55.07% and 66.84%, respectively, indicating that 2-amino-3-(4-hydroxyphenyl) butyric acid can stimulate plants to generate immunity against Pseudomonas syringae, inhibit the accumulation of bacteria in plant leaves and reduce the morbidity level of the plants.

### Embodiment 4 2-Amino-3-Hydroxy-3-Methylbutyric Acid and 2-Amino-3-(4-Hydroxyphenyl) Butyric Acid Induce Wheat to Resist Infection of Powdery Mildew Fungi

Take 2-amino-3-hydroxy-3-methylbutyric acid, dissolve it in distilled water, then dilute the solution with distilled water by gradient into 10 nM, 100 nM, 1,000 nM and 10,000 nM solutions, and set a blank control. Accelerate germination of wheat (NAU0686) seeds, then sow them in sterilized soil bowls, and culture them in a greenhouse of 23 (±1)° C. and 12 h illumination. Spray the 2-amino-3-hydroxy-3-methylbutyric acid solutions at the above concentrations to the stems and leaves of wheat seedlings when the seedlings have grown to have one leaf and one shoot, at an interval of 24 h and twice in total, evenly sprinkle fresh powdery wheat spores on the wheat leaves after 24 h, 3 pots each treatment, 20 plants per pot. Investigate the morbidity level of the wheat in each treatment after 10 d, record the morbidity level according to the wheat powdery mildew grading standard in the Pesticide—Guidelines for the Field Efficacy Trials(I) and calculate the disease index and relative immune effect by the calculation method same as that for the disease index and relative immune effect of tomato spotted wilt. The results are as shown in Table 5. Wheatpowdery mildew grading standard (with leaf as a unit):
Level 1: The area of the disease spots accounts for less than 5% of the whole leaf area;
Level 3: The area of the disease spots accounts for6%-15% of the whole leaf area;
Level 5: The area of the disease spots accounts for 16%-25% of the whole leaf area;
Level 7: The area of the disease spots accounts for26%-50% of the whole leaf area;
Level 9: The area of the disease spots accounts for more than 50% of the whole leaf area.

TABLE 5
Effects of2-amino-3-hydroxy-3-methylbutyric
acid at different concentrations on the disease
index and relative immune effect of wheat

| Treatment concentration | | Disease index | Relative immune effect(%) |
|---|---|---|---|
| 0 | | 90.00 ± 3.95 a | 0 |
| 10 | nM | 74.83 ± 0.13b | 16.85 |
| 100 | nM | 64.89 ± 0.80c | 27.90 |
| 1,000 | nM | 47.48 ± 3.19 d | 47.24 |
| 10,000 | nM | 30.89 ± 1.14e | 65.68 |

The results in Table 5 show that with the increase of the concentration of 2-amino-3-hydroxy-3-methylbutyric acid, the disease index of susceptible wheat varieties decreases and the relative immune effect increases. There are significant differences in disease index among all treatments. When the concentration is 10 nM, 100 nM, 1,000 nM and 10,000 nM, the disease index is 74.83, 64.89 and 47.48 and 30.89, respectively and the relative immune effect is 16.85%, 27.90%, 47.24% and 65.68%, respectively. When the concentration of 2-amino-3-hydroxy-3-methylbutyric acid is greater than or equal to 1,000 nM, the disease index of susceptible wheat varieties infected with powdery mildew is lower than 50, while the relative immune effect exceeds40%, and the effect is the best at the concentration of 10,000 nM. The above results indicate that 2-amino-3-hydroxy-3-methylbutyric acid can improve the immunity of wheat against fungal disease powdery mildew, thereby inhibiting the infection and diffusion of powdery mildew in wheat leaves and preventing the development and spread of wheat powdery mildew.

By the same method, observe the effect of 2-amino-3-(4-hydroxyphenyl) butyric acid in inducing wheat to resist infection of powdery mildew. The results are shown in Table 6:

TABLE 6
Effects of 2-amino-3-(4-hydroxyphenyl) butyric
acidat different concentrations on the disease
index and relative immune effect of wheat

| Treatment concentration | | Disease index | Relative immune effect(%) |
|---|---|---|---|
| 0 | | 95.56 ± 1.81 a | 0 |
| 10 | nM | 76.28 ± 0.14 b | 20.17 |
| 100 | nM | 62.19 ± 0.43 c | 34.92 |
| 1,000 | nM | 40.70 ± 3.19 d | 57.40 |
| 10,000 | nM | 27.59 ± 2.77 e | 71.12 |

The results in Table 6 show that with the increase of the concentration of 2-amino-3-(4-hydroxyphenyl) butyric acid, the disease index of susceptible wheat varieties decreases and the relative immune effect increases. There are significant differences in disease index among all treatments. When the concentration is 10 nM, 100 nM, 1,000 nM and 10,000 nM, the disease index is 76.28, 62.19, 40.70 and 27.59, respectively and the relative immune effect is 20.17%, 34.92%, 57.40% and 71.12%, respectively. When the concentration of 2-amino-3-(4-hydroxyphenyl) butyric acid is 1,000 nM, the disease index of susceptible wheat varieties infected with powdery mildew is lower than 50, while the relative immune effect exceeds50% and the effect is the best at the concentration of 10,000 nM. The above results indicate that 2-amino-3-(4-hydroxyphenyl) butyric acid can improve the immunity of wheat against fungal disease powdery mildew, thereby inhibiting the infection and diffusion of powdery mildew in wheat leaves and preventing the development and spread of wheat powdery mildew.

### Embodiment 5 Field Test of 2-Amino-3-Hydroxy-3-Methylbutyric Acid and 2-Amino-3-(4-Hydroxyphenyl) Butyric Acid in Inducing Wheat to Resist Infection of Powdery Mildew

Spraya 2-amino-3-hydroxy-3-methylbutyric acid solution (surfactant Tween 20 (0.02% (v/v) is added) at a concentration of 1,000 nM on stems and leaves in the field of Jiangsu Academy of Agricultural Sciences, use surfactant Tween 20 with a spray volume percent of 0.02% as an additive control, Atailing with 30 g sprayed per mu as a positive control, and repeat each treatment for three times. Investigate the wheat morbidity level of each treatment, record the morbidity level according to the wheat powdery mildew grading standard in the Pesticide—Guidelines for the Field Efficacy Trials(I) and calculate the disease index and relative immune effect by the calculation method same as that for the disease index and relative immune effect of tomato spotted wilt. After drying of the harvested wheat seeds, determine the thousand kernel weight of the wheat seeds under different treatments. The wheat powdery mildew grading standard (with leaf as a unit):
Level 1: The area of the disease spots accounts for less than 5% of the whole leaf area;
Level 3: The area of the disease spots accounts for 6%-15% of the whole leaf area;
Level 5: The area of the disease spots accounts for 16%-25% of the whole leaf area;
Level 7: The area of the disease spots accounts for 26%-50% of the whole leaf area;
Level 9: The area of the disease spots accounts for more than 50% of the whole leaf area.

TABLE 7
Effects of 2-amino-3-hydroxy-3-methylbutyric acid at a
concentration of 1,000 nM on the disease index, relative
immune effect and thousand kernel weight of wheat

| | | Relative | |
|---|---|---|---|
| | | immune | Thousand kernel |
| Treatment | Disease index | effect(%) | weight(g) |
| Additive control | 79.41 ± 2.82 a | 0 | 24.75 ± 0.37 c |
| Atailing (30 g/mu) | 55.17 ± 0.78 b | 30.52 | 29.75 ± 0.31 b |
| 1,000 nM | 48.64 ± 0.46 c | 38.74 | 32.61 ± 0.18 a |

The results in Table 7 show that treatment with a 2-amino-3-hydroxy-3-methylbutyric acid solution at a concentration of 1,000 nM can effectively improve the immunity of wheat against fungal disease powdery mildew, the disease index of the wheat treated at this concentration is significantly lower than that of the additive control group, and the relative immune effect and thousand kernel weight of the wheat are significantly higher than those of the additive control group; compared to the positive control Atailing, the relative immune effect and thousand kernel weight of the wheat treated with2-amino-3-hydroxy-3-methylbutyric acid solution at a concentration of 1,000 nM are even higher, indicating that spraying 2-amino-3-hydroxy-3-methylbutyric acid can effectively improve the immunity of wheat against fungal disease powdery mildew.

By the same method, do a field test of 2-amino-3-(4-hydroxyphenyl) butyric acid in inducing wheat to resist infection of powdery mildew. The results are shown in Table 8:

TABLE 8
Effects of 2-amino-3-(4-hydroxyphenyl) butyric acid on the disease
index, relative immune effect and thousand kernel weight of wheat

| | | Relative | |
|---|---|---|---|
| | | immune | Thousand kernel |
| Treatment | Disease index | effect(%) | weight(g) |
| Additive control | 53.81 ± 1.35 a | 0 | 29.14 ± 0.32 b |
| Atailing (30 g/mu) | 41.06 ± 0.95 b | 23.69 | 35.86 ± 0.13 a |
| 1,000 nM | 28.37 ± 2.28 b | 47.28 | 37.92 ± 0.21 a |

The results in Table 8 show that treatment with a 2-amino-3-(4-hydroxyphenyl) butyric acid solution at a concentration of 1,000 nM can effectively improve the immunity of wheat against fungal disease powdery mildew, the disease index of the wheat treated at this concentration is significantly lower than that of the additive control group, and the relative immune effect and thousand kernel weight of the wheat are significantly higher than those of the additive control group and the positive control Atailing group, indicating that spraying 2-amino-3-(4-hydroxyphenyl) butyric acid can effectively improve the immunity of wheat against fungal disease powdery mildew.

### Embodiment 6 2-Amino-3-Hydroxy-3-Methylbutyric Acid and 2-Amino-3-(4-Hydroxyphenyl) Butyric Acid Induce Arabidopsis to Resist High-Temperature Stress

Take 2-amino-3-hydroxy-3-methylbutyric acid, dissolve it with distilled water, then dilute the solution with distilled water by gradient into 10 nM, 100 nM, 1,000 nM and 10,000 nM solutions, set a blank control, and meanwhile add 0.02% Tween 20 as a surfactant. Set 4 groups for each concentration and meanwhile set a room-temperature blank control. Sow about 50 Arabidopsis seeds in each bowl with a diameter of 8.5 cm, and grow in a greenhouse at 25° C., RH 60%-70% and luminous intensity of 200 μmol m⁻²s⁻¹(16 h illumination/8 h darkness). Start treatment in 21 d of the Arabidopsis seedling stage by the method of spraying a 2-amino-3-hydroxy-3-methylbutyric acid solution on the leaf surface twice in 24 h. 24 h after the second treatment, transfer them to an illumination incubator of 45° C. for high-temperature stress treatment, and after 12 h, conduct dark treatment at room temperature for 30 min, then determine the chlorophyll fluorescence of Arabidopsis leaves by plant efficiency Handy-PEA, then transfer the plants to a 25° C. greenhouse and recover them for 7 d, observe and calculate the damage condition of the plants and calculate the heat damage levels. The heat damage grading standard is shown in Table 9 and the heat damage index calculation formula is as follows. The results of heat damage and fluorescence parameters are shown in Table 6.

$$Heat damage index ( \% ) = \frac{\sum Number of plants at each level \times Number of levels}{The highest level \times Total number of treated plants} \times 100 \%$$

TABLE 9
Heat damage grading standard

| Heat damage level | Damage degree |
|---|---|
| 0 | The plant grows normally |
| 1 | Less than ¼ of the leaves are wilted |
| 2 | ¼-½ of the leaves are wilted or turn yellow |
| 3 | ½-¾ of the leaves are wilted or turn yellow |
| 4 | More than ¾ of the leaves are wilted or turn yellow |
| 5 | The plant is dead |

TABLE 10
Effect of 2-amino-3-hydroxy-3-methylbutyric acid
onArabidopsis under high-temperature stress

| Treatment concentration | | PI_{ABS} | Heat damage index(%) |
|---|---|---|---|
| Blank control | | 16.69 ± 1.86 a | 0 |
| 0 | | 7.59 ± 0.77 d | 80 |
| 10 | nM | 10.60 ± 0.32 c | 60 |
| 100 | nM | 11.27 ± 0.89 c | 45 |
| 1,000 | nM | 13.61 ± 0.38 b | 20 |
| 10,000 | nM | 15.60 ± 0.78 ab | 15 |

The results in Table 10 show that the PI_{ABS} of Arabidopsis treated with 2-amino-3-hydroxy-3-methylbutyric acid is significantly higher than that of the blank control after high-temperature stress. The heat damage index decreases with the increase of treatment concentration. The effect at 10,000 nM is the best. The PI_{ABS} of Arabidopsis treated at this concentration increases by 106% and the heat damage index decreases by 65%. It can be seen that2-amino-3-hydroxy-3-methylbutyric acid can alleviate the damage of high-temperature stress to the photosynthetic system of Arabidopsis plants and improve the resistance to Arabidopsis to high-temperature stress.

### Embodiment 7 2-Amino-3-(4-Hydroxyphenyl) Butyric Acid and 2-Amino-3-(4-Hydroxyphenyl) Butyric Acid Induce Ryegrass to Resist High-Temperature Stress

Take 2-amino-3-(4-hydroxyphenyl) butyric acid, dissolve it with distilled water, then dilute the solution with distilled water by gradient into 1 nM, 10 nM, 100 nM and 1,000 nM solutions, set a blank control, and meanwhile add 0.02% Tween 20 as a surfactant. Set 4 groups for each concentration and meanwhile set a room-temperature blank control. Weigh 0.8 g of ryegrass seeds per bowl, sow them in bowls with a diameter of 8.5 cm, and grow in a greenhouse at 25° C., RH 60%-70% and luminous intensity of 200 μmol m⁻²s⁻¹(12 h illumination/12 h darkness). Start treatment after ryegrass has grown for 7 dby the method of spraying a 2-amino-3-(4-hydroxyphenyl) butyric acid solution on the leaf surface twice in 24 h.24 h after the second treatment, transfer them to an illumination incubator of 45° C. for high-temperature stress treatment, and after 12 h, conduct dark treatment at room temperature for 30 min, then determine the chlorophyll fluorescence of Arabidopsis leaves by plant efficiency Handy-PEA, then transfer the plants to a 25° C. greenhouse and recover them for 7 d, observe and calculate the damage condition of the plants and calculate the heat damage levels. The heat damage grading standard is shown in Table 9 and the heat damage calculation formula is as follows. The results of heat damage and fluorescence parameters are shown in Table 11.

$$Heat damage index ( \% ) = \frac{\sum Number of plants at each level \times Number of levels}{The highest level \times Total number of treated plants} \times 100 \%$$

TABLE 11
Effect of 2-amino-3-(4-hydroxyphenyl) butyric
acid on ryegrass under high-temperature stress

| Treatment concentration | | PI_{ABS} | Heat damage index(%) |
|---|---|---|---|
| Blank control | | 10.07 ± 1.46a | 0 |
| 0 | | 0.56 ± 0.16c | 90 |
| 1 | nM | 0.78 ± 0.23bc | 81 |
| 10 | nM | 0.95 ± 0.41bc | 66.67 |
| 100 | nM | 1.50 ± 0.54b | 55 |
| 1,000 | nM | 2.61 ± 1.05ab | 35 |

The results in Table 11 show that the PI_{ABS} of ryegrass treated with 2-amino-3-(4-hydroxyphenyl) butyric acid is significantly higher than that of the blank control after high-temperature stress, the heat damage index decreases with the increase of treatment concentration, the effect at 10,000 nM is the best, and the PI_{ABS} of ryegrass treated at this concentration increases by 366% and the heat damage index decreases by 55%. It can be seen that2-amino-3-(4-hydroxyphenyl) butyric acid can alleviate the damage of high-temperature stress to the photosynthetic system of ryegrass and improve the resistance to ryegrass to high-temperature stress.

### Embodiment 8 2-Amino-3-Hydroxy-3-Methylbutyric Acid and 2-Amino-3-(4-Hydroxyphenyl) Butyric Acid Induce Tea Trees to Resist Low-Temperature Stress

The tea trees for test are cutting seedling Baiye 1#. Select tea seedlings with consistent growth, move them into plastic bowls with a diameter of 18 cm, put them in a greenhouse of 25° C. and RH 60%-70%, adapt to growth for about one week, and carry out the test. Set concentrations at 0, 10, 100, 1,000 and 10,000 nM, and meanwhile, add 0.02% Tween 20 as a surfactant. The spray treatment method is the same as the Arabidopsis treatment method in Embodiment 6, the time of low-temperature stress is 24 h, and the temperature is set at −4° C. Take out tea seedlings after stress, conduct dark treatment at room temperature for 30 min, then determine the chlorophyll fluorescence of leaves at the top of tea seedlings by plant efficiency Handy-PEA, then put them in a 25° C. greenhouse and recover them for 3 d, observe and calculate the cold damage condition and grade it. The statistics and grading standard of the cold damage index is shown in Table 12, the calculation formula is as follows and the results are as shown in Table 13.

$$Heat damage index ( \% ) = \frac{\sum Number of plants at each level \times Number of levels}{The highest level \times Total number of treated plants} \times 100 \%$$

TABLE 12
Cold damage grading standard

| Cold damage | |
|---|---|
| level | Damage degree |
| 0 | The plant grows normally |
| 1 | The leaf margin loses water slightly |
| 2 | The leaf margin loses water seriously |
| 3 | The leaf margin loses water seriously, and leaves have |
| | dehydration spots |
| 4 | The leaf margin loses water seriously, the dehydration |
| | spots of the leaves are connected into pieces, and some |
| | of the leaves are wrinkled |
| 5 | The whole leaf is wrinkled and wilted due to dehydration |

TABLE 13
Effect of treatment with 2-amino-3-hydroxy-3-methylbutyric
acid on tea under low-temperature stress

| Treatment concentration | | PI_{ABS} | Cold damage index (%) |
|---|---|---|---|
| 0 | | 23.21 ± 2.10d | 75 |
| 10 | nM | 28.35 ± 1.66c | 65 |
| 100 | nM | 30.67 ± 2.07bc | 45 |
| 1,000 | nM | 35.23 ± 1.96b | 30 |
| 10,000 | nM | 40.16 ± 2.15a | 15 |

The results in Table 13 show that the PI_{ABS} of tea treated with 2-amino-3-hydroxy-3-methylbutyric acid increases significantly and the cold damage index decreases obviously with the increase of concentration under the condition of low-temperature stress. The effect of the treatment at 10,000 nM is the best. The PI_{ABS} of the tea treated at this concentration increases by 73% and the cold damage index decreases by 60%. It can be seen that 2-amino-3-hydroxy-3-methylbutyric acid can alleviate the damage of low-temperature stress to the photosynthetic system of tea seedlings and improve the resistance of tea to low-temperature stress.

By the same method, observe the effect of 2-amino-3-(4-hydroxyphenyl) butyric acid in inducing tea trees to resist low-temperature stress. The results are as shown in Table 14:

TABLE 14
Effect of treatment with2-amino-3-(4-hydroxyphenyl)
butyric acid on tea under low-temperature stress

| Treatment concentration | | PI_{ABS} | Cold damage index (%) |
|---|---|---|---|
| 0 | | 20.21 ± 0.99e | 70 |
| 1 | nM | 28.10 ± 3.10cd | 60 |
| 10 | nM | 31.94 ± 1.37bc | 55 |
| 100 | nM | 34.67 ± 3.27ab | 35 |
| 1,000 | nM | 38.56 ± 2.23a | 30 |

The results in Table 14 show that the PI_{ABS} of tea treated with 2-amino-3-(4-hydroxyphenyl) butyric acid increases significantly and the cold damage index decreases obviously under low-temperature stress. The effect at 10,000 nM is the best. The PI_{ABS} of the tea treated at this concentration increases by 90.8% and the cold damage index decreases by 40%. It can be seen that2-amino-3-(4-hydroxyphenyl) butyric acid can alleviate the damage of low-temperature stress to the photosynthetic activity of tea seedlings and improve the resistance of tea to low-temperature stress.

### Embodiment 9 2-Amino-3-Hydroxy-3-Methylbutyric Acid and 2-Amino-3-(4-Hydroxyphenyl) Butyric Acid Induce Wheat to Resist Drought Stress

Use a 6-mesh screen as a container for hydroponic culture of wheat, 50 grains per screen, replace the ½ Hoagland nutrient solution once every two days, spray 2-amino-3-hydroxy-3-methylbutyric acid solutions at2-amino-3-hydroxy-3-methylbutyric acid concentrations of 0, 100 and 1,000 nM when the wheat grows to the stage of two leaves and one shoot, and meanwhile, add 0.02% Tween 20 as a surfactant; after two days of continuous spray, replace the hydroponic nutrient solution with a ½ Hoagland nutrient solution containing 25% PEG-6000 for stress treatment,rewater after 6 d of drought stress, recover growth in a normal nutrient solution for 7 d, then observe and determine the drought damage index, and determine the root length and biomass. The results are as shown in Table 16.

The manifestation features after drought damage of leaves are similar to those after salt damage. By taking reference to the salt damage evaluation indexes, drought damage rate and drought damage index are introduced. The drought damage index formula is as follows and the drought damage grading standard is shown in Table 15.

$$Cold damage index ( \% ) = \frac{\sum Cold damage level \times Number of cold damage levels}{The highest cold damage level \times Total number of plants} \times 100$$

TABLE 15
Drought damage grading standard

| Drought damage | |
|---|---|
| level | Damage degree |
| 0 | No drought damage symptoms |
| 1 | The drought damage is mild, and the apexes, margins |
| | or veins of a minority of leaves turn yellow |
| 2 | The drought damage is moderate, and about ½ of |
| | the leaf apexes and margins are dried up |
| 3 | The drought damage is serious, and most of the leaf |
| | apexes and margins are dried up or leaves fall |

TABLE 16
Effects of treatment with 2-amino-3-hydroxy-3-methylbutyric acid on
the biomass and drought damage index of wheat under drought stress

| | | | | | | | Drought |
|---|---|---|---|---|---|---|---|
| | | Fresh weight (g) | | Dry weight (g) | | Root | damage |
| Treatment | | Overground | Underground | Overground | Underground | length | index |
| concentration | | part | part | part | part | (cm) | (%) |
| 0 | | 6.10 ± 0.05c | 2.89 ± 0.02c | 0.69 ± 0.03c | 0.32 ± 0.01b | 13.10 ± 0.20b | 77 |
| 100 | nM | 7.27 ± 0.02b | 3.65 ± 0.01b | 0.80 ± 0.01b | 0.33 ± 0.01a | 13.94 ± 0.03a | 45 |
| 1,000 | nM | 8.84 ± 0.09a | 4.48 ± 0.02a | 0.92 ± 0.05a | 0.37 ± 0.01a | 14.58 ± 0.01a | 26 |

The results of Table 16 show that with the increase of treatment concentration, the resistance of wheat to drought stress increases gradually. The fresh weight, dry weight and root length of the wheat at two treatment concentrations are higher than those in the control group, making the drought damage index of wheat decrease obviously. Compared to the control, treatment with 2-amino-3-hydroxy-3-methylbutyric acid at a concentration of 1,000 nM makes the root length of wheat seedlings increase by 11.30%, the fresh weight of the overground part and that of the underground part increase by 44.92% and 55.02%, respectively and the drought damage index decrease by 51%, indicating that 2-amino-3-hydroxy-3-methylbutyric acid can improve the resistance of wheat to drought stress.

By the same method, observe the effect of 2-amino-3-(4-hydroxyphenyl) butyric acid in inducing wheat to resist drought stress. The results are as shown in Table 17:

TABLE 17
Effects of treatment with 2-amino-3-(4-hydroxyphenyl) butyric acid on
the biomass and drought damage index of wheat under drought stress

| | | Fresh weight(g) | | Dry weight(g) | | Root | Drought |
|---|---|---|---|---|---|---|---|
| Treatment | | Overground | Underground | Overground | Underground | length | damage |
| concentration | | part | part | part | part | (cm) | index(%) |
| 0 | | 6.11 ± 0.08c | 2.90 ± 0.05c | 0.71 ± 0.02b | 0.30 ± 0.02b | 13.16 ± 0.21b | 74 |
| 100 | nM | 7.34 ± 0.18b | 3.70 ± 0.03b | 0.83 ± 0.01a | 0.36 ± 0.01a | 14.02 ± 0.03a | 47 |
| 1,000 | nM | 8.90 ± 0.15a | 4.58 ± 0.01a | 0.93 ± 0.05a | 0.39 ± 0.01a | 14.67 ± 007a | 25 |

The results of Table 17 show that with the increase of treatment concentration, the resistance of wheat to drought stress increases gradually. The fresh weight, dry weight and root length of the wheat at two treatment concentrations are higher than those in the control group, making the drought damage index of wheat decrease obviously. Compared to the control, treatment with2-amino-3-(4-hydroxyphenyl) butyric acidity a concentration of 1,000 nM makes the root length of wheat seedlings increase by 11.47%, the fresh weight of the overground part and that of the underground part increase by 45.66% and 57.93%, respectively and the drought damage index decrease by 49%, indicating that 2-amino-3-(4-hydroxyphenyl) butyric acid can improve the resistance of wheat to drought stress.

### Embodiment 10 2-Amino-3-Hydroxy-3-Methylbutyric Acid and 2-Amino-3-(4-Hydroxyphenyl) Butyric Acid Induce Cotton to Resist Salt Stress

The experimental material is “Si Kang 1#” cotton. Use 500 mL plastic cups for hydroponic culture and replace the ½Hoagland nutrient solution once every two days. Spray a 2-amino-3-hydroxy-3-methylbutyric acid solution on the leaf surface when the cotton seedlings grow until the second true leaf is fully open, set the concentrations at 0, 1, 10, 100 and 1,000 nM in the experiment, and add 0.02% Tween 20 as a surfactant. Spray once every 24 h, twice in total, add NaCl to the ½Hoagland nutrient solution on the second day after treatment to make its final concentration be 100 mM, and conduct salt stress treatment. Repeat each treatment three times. Rewater after three days of salt stress, observe the salt damage symptoms of cotton, and calculate the salt damage index by the following formula:

$$Drought damage index ( \% ) = \frac{\sum Drought damage level \times Number of drought damage plants}{Total number of plants \times The highest level of drought damage} \times 100$$

TABLE 18
Salt damage grading standard

| Salt damage | |
|---|---|
| level | Damage degree |
| 1 | The plant height and number of leaves are equivalent to |
| | those in the control, the plants are robust, and the leaves are |
| | open, flat, green and glossy; the growth is normal, without |
| | damage symptoms. |
| 2 | The plant heightis 70%-100% of that of the control, the true |
| | leaves are 0.5-1.0 leaf fewer than those in the control, the |
| | cotyledon is open and flat, the salt damage symptoms are |
| | not obvious, and the growth is basically normal |
| 3 | The plant heightis 50%-70% of that of the control, the true |
| | leaves are 1.0 leaf fewer than those in the control, and the |
| | cotyledon edge is curled. |
| 4 | The plant heightis less than 50% of that of the control, |
| | there is no true leaf, only lobus cardiacus survives, the |
| | growth point is passivated, the cotyledon is in dark green |
| | and wrinkled, and the edge is curled. |
| 5 | The cotyledon falls off and the plant dries up and dies. |

TABLE 19
Effect of treatment of 2-amino-3-hydroxy-3-methylbutyric
acid on cotton under salt stress

| Treatment concentration | | Salt damage index(%) | Death rate (%) |
|---|---|---|---|
| 0 | | 75 | 71 |
| 1 | nM | 66 | 51 |
| 10 | nM | 58 | 47 |
| 100 | nM | 54 | 34 |
| 1,000 | nM | 48 | 30 |

The results of Table 19 show that with the increase of the concentration of 2-amino-3-hydroxy-3-methylbutyric acid, the salt damage index of cotton decreases, and the death rate of each treated plant is lower than that of the control. When the concentration is 1,000 nM, the salt damage index and death rate are both the lowest, 48% and 30%, respectively. The above results indicate that 2-amino-3-hydroxy-3-methylbutyric acid can induce cotton to better resist salt stress.

By the same method, observe the effect of2-amino-3-(4-hydroxyphenyl) butyric acid in inducing cotton to resist salt stress. The results are as shown in Table20:

TABLE 20
Effect of treatment with 2-amino-3-(4-hydroxyphenyl)
butyric acid on cotton under salt stress

| Treatment concentration | | Saltdamage index(%) | Death rate (%) |
|---|---|---|---|
| 0 | | 78 | 70 |
| 1 | nM | 64 | 48 |
| 10 | nM | 56 | 45 |
| 100 | nM | 52 | 30 |
| 1,000 | nM | 43 | 29 |

The results of Table 20 show that with the increase of the concentration of 2-amino-3-(4-hydroxyphenyl) butyric acid, the salt damage index of cotton decreases, and the death rate of each treated plant is lower than that of the control. When the concentration is 1,000 nM, the salt damage index and death rate are both the lowest, 43% and 29%, respectively. The above results indicate that2-amino-3-(4-hydroxyphenyl) butyric acid can induce cotton to better resist salt stress.

Chemically synthesized2-amino-3-hydroxy-3-methylbutyric acid and 2-amino-3-(4-hydroxyphenyl) butyric acid also have the same effects as the biologically extracted 2-amino-3-hydroxy-3-methylbutyric acid and 2-amino-3-(4-hydroxyphenyl) butyric acid. The methods for preparing 2-amino-3-hydroxy-3-methylbutyric acid and 2-amino-3-(4-hydroxyphenyl) butyric acid do not affect their use and effects as immune resistance inducers.

1. A method for preparing a plant immune resistance inducer comprising preparing a composition comprising 2-amino-3-hydroxy-3-methylbutyric acid and/or 2-amino-3-(4-hydroxyphenyl) butyric acid.

2. A method for improving the resistance of plants to biotic stress and abiotic stress comprising treating the plants with 2-amino-3-hydroxy-3-methylbutyric acid and/or 2-amino-3-(4-hydroxyphenyl) butyric acid, wherein the abiotic stress is selected from any one or more of high-temperature, low-temperature, drought and salt stresses, the biotic stress being selected from any one or more of fungal, bacterial and viral stresses, the fungal disease being wheat powdery mildew, the bacterial disease being Pseudomonas syringae disease and the viral disease being tomato spotted wilt.

3. The method according to claim 1, wherein the plants are selected from grain crops, cash crops and vegetables.

4. The method according to claim 3, wherein the grain crop is wheat, the cash crop being ryegrass, tea or cotton, and the vegetable being tomato.

5. A plant immune resistance inducer, wherein the plant immune resistance inducer contains component A: any one or two of 2-amino-3-hydroxy-3-methylbutyric acid and 2-amino-3-(4-hydroxyphenyl) butyric acid; and component B: surfactant.

6. The plant immune resistance inducer according to claim 5, wherein the surfactant is Tween 20.

7. The plant immune resistance inducer according to claim 6, wherein the concentration of Tween 20 in the plant immune resistance inducer is 0.01˜0.05% (v/v).

8. The plant immune resistance inducer according to claim 5, wherein the concentration of 2-amino-3-hydroxy-3-methylbutyric acid or 2-amino-3-(4-hydroxyphenyl) butyric acid in the plant immune resistance inducer is 0.1-10,000 nM.

9. A method for improving the resistance of plants to biotic stress and abiotic stress, wherein 0.1-10,000 nM 2-amino-3-hydroxy-3-methylbutyric acid or 2-amino-3-(4-hydroxyphenyl) butyric acid or the plant immune resistance inducer in claim 5 is applied to a target plant.

10. The method according to claim 9, wherein the abiotic stress is selected from any one or more of high-temperature, low-temperature, drought and salt stresses, the biotic stress being selected from any one or more of fungal, bacterial and viral stresses, the fungal disease being wheat powdery mildew, the bacterial disease being Pseudomonas syringae disease, and the viral disease being tomato spotted wilt.

11. The method according to claim 2, wherein the plants are selected from grain crops, cash crops and vegetables.

12. The method according to claim 11, wherein the grain crop is wheat, the cash crop being ryegrass, tea or cotton, and the vegetable being tomato.

13. A method for improving the resistance of plants to biotic stress and abiotic stress, wherein 0.1-10,000 nM 2-amino-3-hydroxy-3-methylbutyric acid or 2-amino-3-(4-hydroxyphenyl) butyric acid or the plant immune resistance inducer in claim 6 is applied to a target plant.

14. A method for improving the resistance of plants to biotic stress and abiotic stress, wherein 0.1-10,000 nM 2-amino-3-hydroxy-3-methylbutyric acid or 2-amino-3-(4-hydroxyphenyl) butyric acid or the plant immune resistance inducer in claim 7 is applied to a target plant.

15. A method for improving the resistance of plants to biotic stress and abiotic stress, wherein 0.1-10,000 nM 2-amino-3-hydroxy-3-methylbutyric acid or 2-amino-3-(4-hydroxyphenyl) butyric acid or the plant immune resistance inducer in claim 8 is applied to a target plant.

16. The method according to claim 13, wherein the abiotic stress is selected from any one or more of high-temperature, low-temperature, drought and salt stresses, the biotic stress being selected from any one or more of fungal, bacterial and viral stresses, the fungal disease being wheat powdery mildew, the bacterial disease being Pseudomonas syringae disease, and the viral disease being tomato spotted wilt.

17. The method according to claim 14, wherein the abiotic stress is selected from any one or more of high-temperature, low-temperature, drought and salt stresses, the biotic stress being selected from any one or more of fungal, bacterial and viral stresses, the fungal disease being wheat powdery mildew, the bacterial disease being Pseudomonas syringae disease, and the viral disease being tomato spotted wilt.

18. The method according to claim 15, wherein the abiotic stress is selected from any one or more of high-temperature, low-temperature, drought and salt stresses, the biotic stress being selected from any one or more of fungal, bacterial and viral stresses, the fungal disease being wheat powdery mildew, the bacterial disease being Pseudomonas syringae disease, and the viral disease being tomato spotted wilt.
